(19) United States
(12) Patent Application Publication
(10) Pub. No.: US 2026/0341547 A1
(43) Pub. Date: Oct. 29, 2026

(54) Radiation-shielding planar formation

(71) Applicant: Arntz Beteiligungs GmbH & Co. KG, Höxter (DE)

(72) Inventors: Markus Rudolph, Beverungen (DE); Alexej Rjasanow, Paderborn (DE); Jörg Seidenkranz, Lauenfoerde (DE)

(21) Appl. No.: 19/652,048

(22) Filed: Apr. 20, 2026

(30) Foreign Application Priority Data
Apr. 24, 2025 (DE) 102025115802.9
May 12, 2025 (DE) 102025118088.1

(51) Int. Cl. G21F 1/10; G21F 1/12; G21F 3/02

(52) U.S. Cl. CPC G21F 1/103; G21F 1/12; G21F 3/02

(57) ABSTRACT

The invention relates to a radiation-shielding planar formation, consisting of a sandwich structure having a core material and at least one cover layer, wherein the core material comprises a mixture of various components. According to the invention, the core material is based on a blend of natural rubber and styrene-butadiene rubber, to which bismuth or bismuth compounds, antimony or antimony compounds, barium sulfate, and/or cerium oxide are added and the at least one cover layer consists of a thermoplastic polyurethane vulcanized onto the core material.

The invention relates to a radiation-shielding planar formation, consisting of a sandwich structure comprising a core material and at least one cover layer, wherein the core material comprises a mixture of various components, according to the preamble of claim 1.

A material for producing structures for protection from radiation is previously known from WO 0219345 A1. These structures are to be used in particular in the medical sector, to protect personnel from an impermissibly high radiation load. The material therein consist of at least two plates arranged one on top of another, one of which consists of lead and the other of a resin, in particular polyester resin or epoxy resin, which contains a filler that improves the mechanical properties of the resin.

CN 102218882 A1 discloses a fabric for producing clothing for shielding and protecting from nuclear radiation.

The fabric comprises a coating made of a thermoplastic polyurethane material on its surface. Furthermore, the composite coating comprises, inter alia, antifouling agent and/or an agent for protection from aging.

JP 2013122398 A2 discloses a radiation-shielding material, consisting of multiple layers. An intermediate layer provided therein comprises a mixture based on tungsten. Furthermore, the intermediate layer comprises multiple laminate layers. Polyester resins, polystyrene resins, or ethylene vinyl acetate copolymers can be used as the material for the laminate layer.

The radiation protection clothing according to DE 10 2019 114 417 A starts from a tungsten layer, which comprises a binder resin. A quantity of tungsten particles is integrated into the binder resin. In addition, the tungsten layer is covered on both sides by a substrate layer, wherein the substrate layer is supplied and applied in each case from a roll by means of rollers. The additional substrate layers can be in the form of fabric, nonwoven material, or also paper or resin film.

A combination of a core lead layer, provided with outer protective layers to obtain an x-ray radiation protection plate is known from CN 110473641 B. In order to improve the absorption properties, the lead layer is subjected to compaction. The at least one additional adsorption layer comprises, inter alia, magnesium oxide powder, magnesium sulfate, barite powder, and barium sulfate powder, supplemented with a modification agent which comprises at least sodium polyacrylate and sodium methyl silicate.

In summary, greatly differing solution approaches for forming radiation-absorbing planar formations are previously known from the prior art. These formations are either used as more or less rigid plates or are part of a piece of radiation protection clothing, for example, an apron for protection from x-ray radiation.

It is apparent that depending on the desired intended use of such radiation protection formations, the material or the material combination used for this purpose has to meet different requirements. On the one hand, this includes a high level of aging resistance, but also an acceptable mass and a sufficient flexibility, in particular if the radiation protection materials are embodied as a piece of clothing or are part of a piece of clothing.

From the statements above, it is therefore the object of the invention to specify a refined radiation-shielding planar formation, which has improved properties in comparison to the prior art, is producible cost-effectively, and has good temperature and aging resistance.

The object of the invention is achieved by a planar formation according to the combination of features as claimed in claim 1 and by the special use of such planar formations according to the teaching of claims 10 and 11, wherein the dependent claims comprise at least expedient designs and refinements.

Accordingly, the invention proceeds from a radiation-shielding planar formation which comprises a sandwich structure. The sandwich structure proceeds from a core layer and at least one cover layer, wherein the core material comprises a mixture of various components.

According to the invention, the core material is based on a blend of natural rubber and styrene-butadiene rubber, to which bismuth or bismuth compounds, antimony or tin, barium sulfate, and/or cerium oxide are added.

The at least one cover layer consists of a thermoplastic polyurethane vulcanized onto the core material.

As a refinement, the at least one cover layer is implemented as a thermoplastic polyurethane film.

Lead or a lead compound can be added to the core material as an alternative component.

The thermoplastic polyurethane film is applied on both sides to the planar formation. This is preferably carried out by vulcanizing.

The thermoplastic polyurethane used is selected with respect to optimum properties in the matters of abrasion resistance and ozone resistance.

The layer thickness of the core material is a multiple of the thickness of the layers made of thermoplastic polyurethane.

The radiation-shielding planar formation according to the invention is preferably formed as plate goods which can be finished.

The production of the radiation-shielding planar formation makes use of a duplication process having vulcanization parameters in the range of a temperature T of essentially 150 °C to 170 °C at a pressure p of essentially 200 bar.

According to the invention, in addition an outer layer or an envelope made of a textile material in the form of a nonwoven coating or formed as a woven fabric, knitted fabric, crocheted fabric, or combination thereof can additionally be provided.

The use of the presented radiation-shielding planar formation as a protective device, lining, paneling of radiation-emitting equipment, devices, or facilities, such as active baggage scanners, food scanners, x-ray machines, or radar facilities or comparable technical equipment is according to the invention.

Furthermore, a use of the radiation-shielding planar formations as personal protective equipment to be worn on the body, for example, in the form of a coat, an apron, a cloak, a head cover, or the like is according to the invention.

1. Radiation-shielding planar formation, consisting of a sandwich structure having a core material and at least one cover layer, wherein the core material comprises a mixture of various components and is based on a blend of natural rubber and styrene-butadiene rubber, to which bismuth or bismuth compounds, antimony, tin, barium sulfate, and/or cerium oxide or the above-mentioned additives lead or lead compounds are added and the at least one cover layer consists of a thermoplastic polyurethane vulcanized onto the core material, furthermore the formation is formed as plate goods that can be finished and additionally an outer layer or an envelope made of a textile material in the form of a nonwoven coating or formed as a woven fabric, knitted fabric, or crocheted fabric or a combination thereof is provided.

2. Radiation-shielding planar formation as claimed in claim 1, characterized in that
the at least one cover layer is formed as a thermoplastic polyurethane film.

3. Radiation-shielding planar formation as claimed in claim 2, characterized in that
the thermoplastic polyurethane film is applied on both sides to the planar formation.

4. Radiation-shielding planar formation as claimed in claim 1, characterized in that
the thermoplastic polyurethane is formed with respect to optimum properties in the direction of abrasion resistance and ozone resistance.

5. Radiation-shielding planar formation as claimed in claim 1, characterized in that
the thickness of the core material is a multiple of the thickness of the layer made of thermoplastic polyurethane.

6. Radiation-shielding planar formation as claimed in claim 1, produced in a duplication process using vulcanization parameters in the range of a temperature T of essentially 150-170 °C at a pressure p of essentially 200 bar.

7. Use of a radiation-shielding planar formation as claimed in claim 1 as a protective device, lining, or paneling of radiation-emitting equipment, devices, or facilities such as active baggage scanners, food scanners, x-ray machines, or similar equipment.

8. Use of a radiation-shielding planar formation as claimed in claim 1 as personal protective equipment to be worn on the body, such as coats, aprons, cloaks, head covers, or similar pieces of clothing.
